(19) United States
(12) Patent Application Publication
(10) Pub. No.: US 2009/0164881 A1
(43) Pub. Date: Jun. 25, 2009

(54) Scan-to-Redact Searchable Documents

(75) Inventors: Jeffrey Segarra, Medway, MA (US); Gyorgy Csatadi, Nagykovacs (HU); Csaba Dudas, Budapest (HU); Gyorgy Reisch, (US)

Correspondence Address: BROMBERG & SUNSTEIN LLP, 125 SUMMER STREET, BOSTON, MA, 02110-1618, US

(73) Assignee: NUANCE COMMUNICATIONS, INC., Burlington, MA (US)

(21) Appl. No.: 12/182,334

(22) Filed: Jul. 30, 2008

Related U.S. Application Data
(60) Provisional application No. 60/952,653, filed on Jul. 30, 2007.

(51) Int. Cl. G06F 17/21

(52) U.S. Cl. 715/230; 715/256

(57) ABSTRACT

An automatic scan-to-redacted electronic document is described. A user input is received which identifies a scanned document. Then the scanned document is automatically processed to produce a corresponding redacted document which having searchable document text and a document image. The searchable document text includes coded redaction text satisfying defined redaction parameters. The document image includes redacted image areas corresponding to redacted elements.

This application claims priority from U.S. Provisional Patent Application 60/952,653, filed Jul. 30, 2007, which is incorporated herein by reference.

### FIELD OF THE INVENTION

The present invention relates to image processing, and more specifically, to scanning and processing of documents.

### BACKGROUND ART

Redaction is the process of blacking out or removing confidential information from documents so that they can be shared. Confidential information may include the name of a person or place of business, the address, telephone number or other identifying information including Social Security or customer numbers. Redaction is most commonly used in legal or governmental organizations, but is also widely used in other industries including finance, insurance, and manufacturing. The purpose of redaction is to keep sensitive information from being distributed with documents that may need to be shared with the public outside of a closed business, governmental or legal process.

When documents exist as paper, redaction starts by making a paper copy of the confidential document. The copy is then given to a proofreader whose job is to identify sensitive areas of information based on a list of keywords or subjects. In a simplified process, the proofreader redacts the words directly on a copy of the document. In a more complex process the initial proofreader will highlight candidates for redaction which will then be reviewed by one or more informed or senior proofreaders who will make the final decision on redaction. Furthermore, notes or comments often need to be attached to the document to identify why areas should be redacted, who did the initial review of the redaction, and who approved the final redaction so follow-up questions or investigations into the redaction can be made. These notes or comments are often coded so that when the final document is redacted and the notes travel with the document to an unauthorized recipient they will not be able to discern why the areas were redacted or guess as to contents of the redacted information. Authorized participants in the redaction process will be able to use the comments or notes and trace the history and purpose of the redaction as may be required in an investigation involving the documents.

Redaction in a paper process uses a black marker applied to the paper document to completely hide or destroy the contents or text in the document. Due to the differences in the density of the marker compared to the original toner or ink on the document and the paper used, complete removal of the information may not be achieved in a satisfactory way. To ensure that the areas are completely removed and can not be identified upon closer examination the redacted document is usually photocopied again before distribution. This achieves a uniform black area over the information to be hidden so that it is impossible to detect the underlying text. Absolute destruction of the confidential information is critical in the redaction process. A paper redaction process requires skilled proofreaders and is quite inefficient compared to a digital process.

In a digital process, similar tools to highlight, comment, and redact document are provided in various software applications where the digital document was either created or can be edited. To speed the process, a proofreader uses a search tool to identify words required for redaction. Upon finding the word in the document, the appropriate tool is used to highlight, comment or redact the words. To further speed the process, the search function may be combined with an automatic redaction or highlight for redaction feature. If the document is redacted directly, the final document is then saved as a final redacted copy ready for distribution. If words are highlighted or commented for redaction, the document is then forwarded to the appropriate person or persons, either through email or by a document management process, for final redaction. As in a paper process, the absolute removal of confidential information must be achieved in all areas of the document including hidden layers or properties of the document.

It is recognized that sharing of information is much easier, more productive, and less expensive when done digitally. Therefore, the need to scan and convert paper to a digital document is ever increasing as paper is migrated into digital processes. Redaction in this sense is usually achieved after the document is converted to a suitable digital format with reliance on the currently available digital tools to accomplish the redaction. The currently available paper to digital tools either produce a text based PDF file from a converted editable document, or a TIFF based image file from the original scanned image file. Each approach has benefits and short comings.

When converting a document to an editable format for redaction from a scanned file, the integrity of the original document is most likely lost in the conversion process. While the text may be 100% accurate, the format, graphics and other elements of the document may be distorted, rearranged or lost altogether. Therefore, this method of converting and redacting a paper document is not optimum.

To prevent compromising the original document, OCR technology can be used to simply identify the areas on the scanned image document that need to be redacted and then apply those changes directly to the image. This is also not an optimum process because the text in the final TIFF image file still remains image only with no way to search the remaining text for important information. And the ability is lost to attach notes or codes to the redacted areas for future investigation or understanding of how and why those areas of redaction where applied. The PDF file format provides a suitable framework to address short comings of current processes while still providing an original image that is an accurate representation of the original document, a text layer to search, and annotation fields for notes and comments.

### SUMMARY OF THE INVENTION

Embodiments of the present invention are directed to an automatic scan-to-redacted electronic document process. A user input is received which identifies a scanned document. Then the scanned document is automatically processed to produce a corresponding redacted document which having searchable document text and a document image. The searchable document text includes coded redaction text satisfying defined redaction parameters. The document image includes redacted image areas corresponding to redacted elements.

In further specific embodiments, the redaction text may be visually highlighted for review. In addition or alternatively, the redaction text may be removed from the redacted document, and placeholder characters substituted for the redaction text. An annotation field may be provided for recording post-redaction comments associated with selected redaction text.

In some embodiments, the processing may use pre-established redaction criteria to identify and produce the redaction text. For example, the redaction criteria may include a set of keywords associated with redaction and/or use of redaction patterns representing patterns of text associated with redaction. In some embodiments, the searchable document text may include bookmarks identifying segments of redaction text. The redacted image areas may be visually distinctive of redaction, such as by highlighting or by having a uniform non-text appearance. The user-input may be produced from a user selectable button on a computer network device or from a user selectable button on a computer display. The redacted document may specifically be a PDF format document or an editable word processor document such as a Microsoft Word document.

### BRIEF DESCRIPTION OF THE DRAWINGS

FIG. 1 shows various steps in the functional flow of an automatic scan-to-redact process according to one embodiment of the present invention.

### DETAILED DESCRIPTION OF SPECIFIC EMBODIMENTS

Embodiments of the present invention are based on scanning and OCR technology, combined with some recognition intelligence, pre-defined keywords with redaction codes, and the PDF file format to produce an automated scan to redacted PDF file process that can be reviewed, annotated and corrected at anytime. The entire process, called a “workflow” can be defined using the application and applied with a single press of a button either within the application itself or assigned to a physical or virtual button on a device. The end result is a “Searchable PDF” file.

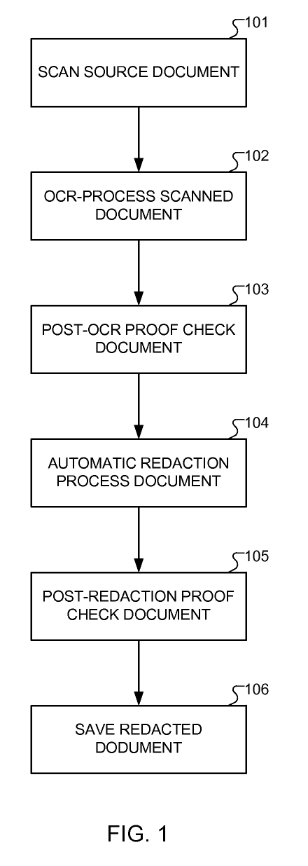

FIG. 1 shows various steps in the functional flow of an automatic scan-to-redact process according to one embodiment of the present invention. First, the source document is scanned, step 101, including initial defining of the scanning process for some image enhancement or corrections. Scanning enhancements improve the OCR recognition capabilities and increase accuracy. Examples of such corrections include without limitation de-skew, despeckle, and auto-rotate. Settings for b/w, grayscale, color and resolution are also set in this step.

Once the document is scanned, an OCR process is applied to the scanned document, step 102. Layout or formatting guidance and language detection is used at this point. For example, as the text is recognized the words are checked against internal dictionaries so that any words not found in the dictionary can be marked as suspect during the OCR text proofreading process. Professional dictionaries including legal, financial and medical are used for even greater accuracy.

When text is checked against the user and professional dictionaries possible mistakes are highlighted during the next step of proofreading the OCR document, step 103. The user checks the accuracy of recognized words in the context of the actual sentence in the document. Corrections may be applied using the proofreading tool. As the words are verified or corrected the user dictionaries “learn” and are updated accordingly to improve the correction process of additionally processed documents.

Once the text has been verified after the OCR proofreading step, the document redaction process can begin, step 104. A user input is received that identifies a scanned document for redaction. For example, the user input may be produced by a user selectable button—either a physical button on a computer network device such as a scanner, etc., or a virtual button produced by software on a computer display. In response to the user input, the scanned document is automatically processed to produce a corresponding redacted document which includes both searchable document text and a document image. The searchable document text includes coded redaction text which satisfies various defined redaction parameters. The document image includes redacted image areas corresponded to the redacted elements.

Established process rules are utilized such as the ability to automatically bookmark document pages for easy identification of redacted text in long documents. Redaction rules may also include use of pre-established redaction criteria to identify and produce the redaction text. For example, redaction patterns may be used which correspond to patterns of text associated with redaction, including automatic markup of information that fits a specific pattern or “looks like” specific information. The pattern could be the format of a number such as a Social Security number, date, currency value or telephone number. A specific list of redaction keywords, redaction codes and notes are loaded from a comma or tab delimited text file or directly from an ODBC database file.

The redaction may be made immediately and directly, or redaction text may be highlighted for further review in a PDF editing application such as PDF Converter Professional. The identified redaction text may usefully be visually distinctive of redaction, for example, having a uniform non-text appearance. In addition, highlighting redaction text candidates for redaction can be customized, for example, with highlight color or an alternative method for identification such as outline or strikethrough can be used. Additionally, redacted areas can have a highlight color applied to a preset number of words or characters before and/or after the redacted areas for easy visual identification. Redacted or highlighted areas can be created with or as annotation fields in the final document.

An additional post-redaction proofreading, step 105, may be employed similar to the post-OCR proofreading step. This checks that possible redaction candidates defined as a pattern or “looks like” are accurately removed or marked as text that must be redacted. Identified words may be displayed in the context of the actual sentence in the document. Tools may be provided to mark or unmark redaction text as required. An alternative to an interactive “redact proofreading” step would be to automatically highlight suspect words in a pre-defined color for review in a PDF editing tool.

The redacted (or redaction highlighted) document can be saved in a propriety application format, step 106, for later review, adjustments at a later date, and or archiving and storage. An embodiment of the application may also read marked PDF files that have been reviewed and marked with highlights in other applications so that the redaction can be automatically applied. When the PDF searchable image files are created, redaction and PDF preferences are applied. Redaction preferences include redaction color, the default being “black”, the width and height tolerance for the redacted area on the image, and a tolerance to objects or text close to the redacted areas so they are not inadvertently corrupted.

A PDF file includes various main components or layers, the most relevant being the image and text layers. The image layer comprises the original scanned document where the redacted areas are replaced with the redacted color and the pixel information is “destroyed”. The text layer is a hidden layer above or below the image that can be indexed and/or searched by commercial search products. The text layer precisely follows the formatting of the original document so that the text selectable in PDF viewing or editing applications in context of the original. The redaction text is removed from the redacted document, and placeholder characters are substituted to form equally spaced text “lines” that, although they can be copied and pasted into other application, do not represent the original text, thereby destroying that information.

Metadata can be applied to the PDF file properties so it can be searched using commercially available search tools. PDF Bookmarks can be automatically created to identify redacted pages. Custom stamps, headers and footers can also be applied to the document to display relevant information such the creator name, creation date, and/or terms and conditions for use of the redacted document. Annotations as notes or redaction/exemption codes are created and applied to the final PDF document.

Standard PDF security tools are also set and applied at this step. This includes password definition in order to view or print a document. 40-bit and 128-bit encryption can also be applied to a PDF file with the user able to control whether the document can be viewed, printed, edited, copied or annotated. The application will also include everything necessary to digitally sign documents for protection and authentication of information. No certificate from a third-party vendor is necessary.

Redaction workflows combine all of the above described steps into a single workflow file that can be named, exported and imported into other copies of the application program so the process can be replicated. Workflows can be initiated as a single step within the application or assigned to physical or virtual buttons on a device for one-button process automation. The application can also batch process files stored on a network utilizing folder watching or automatically process incoming files from email applications. Scanned, recognized and redacted Searchable PDF files can be automatically saved to local hard drives, be saved to document management systems or emailed to specific recipients. The application can also save the files as editable Microsoft Word documents.

Embodiments of the invention may be implemented in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of producing a redacted electronic document, the method comprising:
receiving a user input identifying a scanned document; and
automatically processing the scanned document to produce a corresponding redacted document which includes:
i. searchable document text including coded redaction text satisfying defined redaction parameters, and
ii. a document image having redacted image areas corresponding to redacted elements.

2. A method according to claim 1, wherein the redaction text is visually highlighted for review.

3. A method according to claim 2, further comprising:
removing the redaction text from the redacted document; and
substituting placeholder characters for the redaction text.

4. A method according to claim 1, wherein the redaction text comprises placeholder characters which substitute for text in the scanned document which satisfies the defined redaction parameters.

5. A method according to claim 1, further comprising:
providing an annotation field for recording post-redaction comments associated with selected redaction text.

6. A method according to claim 1, wherein the processing uses pre-established redaction criteria to identify and produce the redaction text.

7. A method according to claim 6, wherein the redaction criteria includes a set of keywords associated with redaction.

8. A method according to claim 6, wherein the redaction criteria includes redaction patterns representing patterns of text associated with redaction.

9. A method according to claim 1, wherein the searchable document text includes bookmarks identifying segments of redaction text.

10. A method according to claim 1, wherein the redacted image areas are visually distinctive of redaction.

11. A method according to claim 10, wherein the redacted image areas have a uniform non-text appearance.

12. A method according to claim 1, wherein the user-input is produced from a user selectable button on a computer network device.

13. A method according to claim 1, wherein the user-input is produced from a user selectable button on a computer display.

14. A method according to claim 1, wherein the redacted document is a PDF format document.

15. A method according to claim 1, wherein the redacted document is an editable word processor document.
